(19) United States
(12) Patent Application Publication
(10) Pub. No.: US 2020/0249346 A1
(43) Pub. Date: Aug. 6, 2020

(54) ELECTRONIC DEVICE FOR CHECKING PROXIMITY OF EXTERNAL OBJECT BY USING SIGNAL IN SPECIFIED FREQUENCY BAND, AND CONTROL METHOD OF ELECTRONIC DEVICE

(71) Applicant: Samsung Electronics Co., Ltd., Gyeonggi-do (KR)

(72) Inventors: Won Sub LIM, Gyeonggi-do (KR); Hyo Seok NA, Gyeonggi-do (KR)

(21) Appl. No.: 16/639,817

(22) PCT Filed: Aug. 27, 2018
(86) PCT No.: PCT/KR2018/009872

§ 371 Date: Feb. 18, 2020

(30) Foreign Application Priority Data
Aug. 28, 2017 (KR) 10-2017-0108808

(51) Int. Cl. G01S 15/04

(52) U.S. Cl. CPC G01S 15/04

(57) ABSTRACT

An electronic device is disclosed. The electronic device according to an embodiment include a communication module, an output device, a microphone, and a processor, wherein the processor acquires an audio signal from an external device using the communication module, outputs a signal corresponding to the audio signal and a signal of a specified frequency band through the output device, acquires the signal of the specified frequency band using the microphone, determines a proximity state of an external object to the electronic device based at least on a strength of the signal of the specified frequency band and controls at least some functions of the electronic device based on at least the determined proximity state. In addition, various embodiments understood from the specification are possible.

### TECHNICAL FIELD

Embodiments disclosed herein relate to a technique for detecting a proximity of an external object using a signal of a specified frequency band.

### BACKGROUND ART

An electronic device may include various sensors such as a touch sensor, an acceleration sensor, a geomagnetic sensor, an illuminance sensor, an RGB sensor, a barometer sensor, a temperature sensor, a proximity sensor, a heart rate sensor, and the like. Such sensors may be used to provide convenience to a user through various applications. For example, when the electronic device detects the proximity of the user through the proximity sensor, the electronic device may turn off a screen of a display to reduce power consumption of the electronic device.

### DISCLOSURE

### Technical Problem

Recently, the number of parts applied to electronic devices has increased and a display size has increased due to the demand for various functions. Moreover, this change leads to an increase in the power consumption of the electronic device, which also leads to an increase in a battery capacity applied to the electronic devices. In general, as the battery capacity increases, the battery size also increases, thereby reducing a space in which the various sensors described above may be mounted in the electronic device.

Various embodiments disclosed in the disclosure provide an electronic device and a method of controlling the electronic device capable of identifying a proximity of an external object using a signal of a specified frequency band.

### Technical Solution

An electronic device according to an embodiment disclosed herein may include a housing, a communication module, a first output unit disposed in a first area of the housing, a second output unit disposed in a second area of the housing, a first microphone disposed closer to the first area than the second area, a second microphone disposed closer to the second area than the first area, and a processor operatively connected to the communication module, the first output unit, the second output unit, the first microphone and the second microphone, wherein the processor may acquire an audio signal from an external device through the communication module, output a signal corresponding to the audio signal and a signal of a specified frequency band through the first output unit and the second output unit, determine a proximity state of an external object to the electronic device based on at least a first strength of the signal of the specified frequency band detected through the first microphone and a second strength of the signal of the specified frequency band detected through the second microphone, and perform a function corresponding to the determined proximity state.

Furthermore, an electronic device according to an embodiment disclosed herein may include a communication module, an output device, a microphone, and a processor, wherein the processor may acquire an audio signal from an external device using the communication module, output a signal corresponding to the audio signal and a signal of a specified frequency band through the output device, acquire the signal of the specified frequency band using the microphone, and determine a proximity state of an external object to the electronic device based at least on a strength of the signal of the specified frequency band and control at least some functions of the electronic device based at least on the determined proximity state.

Furthermore, an electronic device according to an embodiment disclosed herein may a housing, a communication module, a first output unit disposed in a first area of the housing, a second output unit disposed in a second area of the housing, a first microphone disposed closer to the first area than the second area, a second microphone disposed closer to the second area than the first area, and a processor operatively connected to the communication module, the first output unit, the second output unit, the first microphone and the second microphone, wherein the processor may output a signal of a specified frequency band through the first output unit and the second output unit, acquire the signal of the specified frequency band using the first microphone and the second microphone, determine a distance between the electronic device and an external object corresponding to the electronic device based at least on a first strength of the signal of the specified frequency band acquired through the first microphone and a second strength of the signal of the specified frequency band acquired through the second microphone, and control at least some functions of the electronic device based on the distance.

### Advantageous Effects

According to embodiments disclosed in the disclosure, proximity of an external object to an electronic device may be detected using a signal of a specified frequency band.

In addition, various effects may be provided that are directly or indirectly identified through this document.

### DESCRIPTION OF DRAWINGS

FIG. 1 illustrates an external view of an electronic device according to an embodiment.

FIG. 2 illustrates a configuration diagram of an electronic device, according to an embodiment.

FIG. 3 illustrates the strength of a signal of a specified frequency band in each proximity state according to an embodiment.

FIG. 4 is a diagram illustrating a transmission/reception path of a signal of a specified frequency band according to an embodiment.

FIG. 5 illustrates a process of mixing an audio signal and a signal of a specified frequency band according to an embodiment.

FIG. 6 illustrates a process of transmitting and receiving an audio signal and a process of receiving a signal of a specified frequency band in a first mode according to an embodiment.

FIG. 7 is a view illustrating a change in magnitude (or strength) of a signal of a specified frequency band when an electronic device changes from a default state to a bottom proximity state.

FIG. 8 illustrates a distance detection process using a signal of a specified frequency band according to an embodiment.

FIG. 9 is a diagram for describing a process of calculating a heart rate using a signal of a specified frequency band, according to an embodiment.

FIG. 10 is a flowchart illustrating a method of detecting a mid-call grip state according to an embodiment.

FIG. 11 is a flowchart illustrating a method of determining a proximity state using signals of a specified frequency band according to an embodiment.

FIG. 12 illustrates a block diagram of an electronic device in a network environment, according to various embodiments.

In the description of the drawings, the same or similar reference numerals may be used for the same or similar components.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to,” “connected with,” or “connected to” another element (e.g., a second element), it means that the element may be coupled with the other element directly (e.g., wiredly), wirelessly, or via a third element.

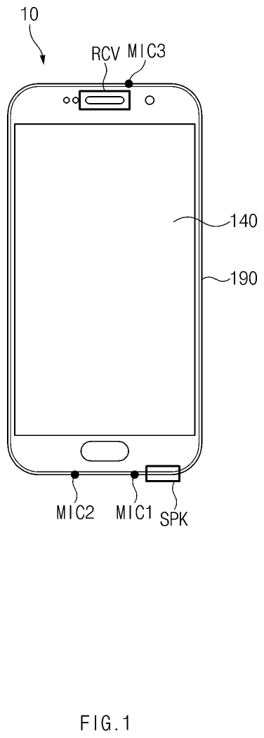

FIG. 1 illustrates an external view of an electronic device according to an embodiment.

Referring to FIG. 1, according to an embodiment, an electronic device 10 may include a housing 190, a display 140, a plurality of microphones MIC1 to MIC3, a receiver RCV, and a speaker SPK. In one embodiment, some components may be omitted, or an additional component may be further included. In one embodiment, some of the components may be combined to form a single entity, but functions of the some components prior to the combination may be performed in the same manner.

According to one embodiment, the housing 190 may fix or incorporate the display 140, the plurality of microphones MIC1 to MIC3, the receiver RCV, and the speaker SPK. The housing 190 may include a front surface, a side surface and a rear surface. At least one opening for exposing the plurality of microphones MIC1 to MIC3, the receiver RCV, or the speaker SPK may be disposed in at least one of the front, rear, and side surfaces of the housing 190.

According to an embodiment, at least a portion of the display 140 may be exposed through the front surface of the housing 190. The display 140 may include a backlight, a display panel, a touch sensor, a pressure sensor, a fingerprint sensor, and the like.

According to an embodiment, the receiver RCV may be disposed in a first area of the housing 190, for example, an upper portion of the front surface of the housing 190. The speaker SPK may be disposed in a second area of the housing 190, for example, in a lower portion of the housing 190. According to various embodiments, the electronic device may include a plurality of speakers SPK, and the plurality of speakers SPK may be disposed on the front, side, or rear surface of the housing 190.

According to an embodiment, the plurality of microphones MIC1 to MIC3 may include first to third microphones MIC1 to MIC3 disposed in a plurality of areas of the housing 190. For example, the first microphone MIC1 and the second microphone MIC2 may be disposed close to the speaker SPK, and the first microphone MIC1 may be disposed to be biased toward a first side surface (e.g., right side) of the housing 190 when viewed from the front surface of the housing 190. The second microphone MIC2 may be disposed to be biased toward a second side surface (e.g., left side) of the housing 190 when viewed from the front surface of the housing 190. The third microphone MIC3 may be disposed close to the receiver RCV.

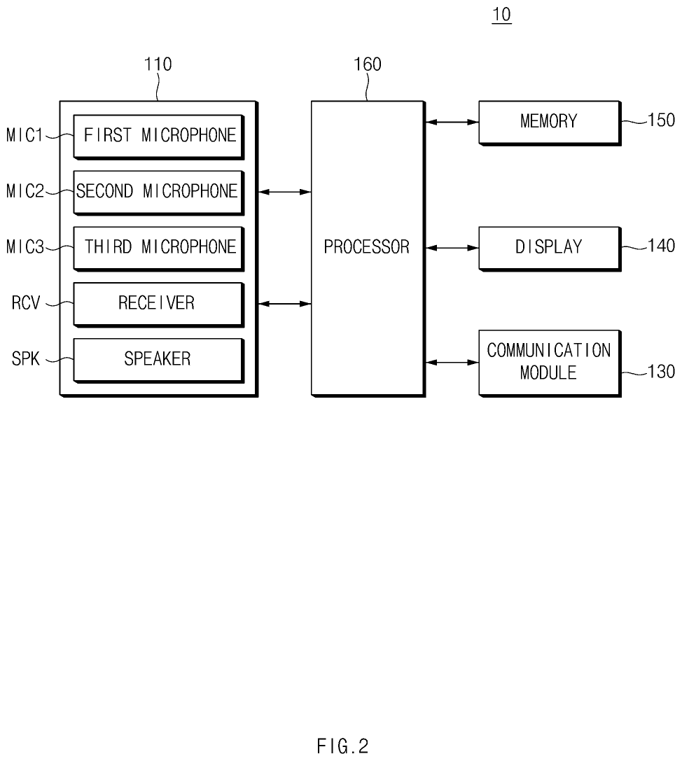

FIG. 2 illustrates a configuration diagram of an electronic device according to an embodiment.

Referring to FIGS. 1 and 2, according to an embodiment, the electronic device 10 may include an input/output device 110, a communication module 130, the display 140, a memory 150, and a processor 160. In one embodiment, some components may be omitted, or an additional component may be further included. In one embodiment, some of the components may be combined to form a single entity, but functions of the some components prior to the combination may be performed in the same manner.

According to an embodiment, the input/output device 110 may include a component that detects a sound (or a signal) or outputs a sound (or a signal). For example, the input/output device 110 may include the receiver RCV, the speaker SPK, and the plurality of microphones MIC1 to MIC3. The sound may include at least one of a sound wave (hereinafter, referred to as an “audio signal”) or a signal of a specified frequency band (e.g., ultrasonic wave). The sound may include a signal converted from an audio signal, a white noise signal, and the like. The white noise signal may be a signal transmitted when a user of another electronic device talking to the electronic device 10 does not make a sound.

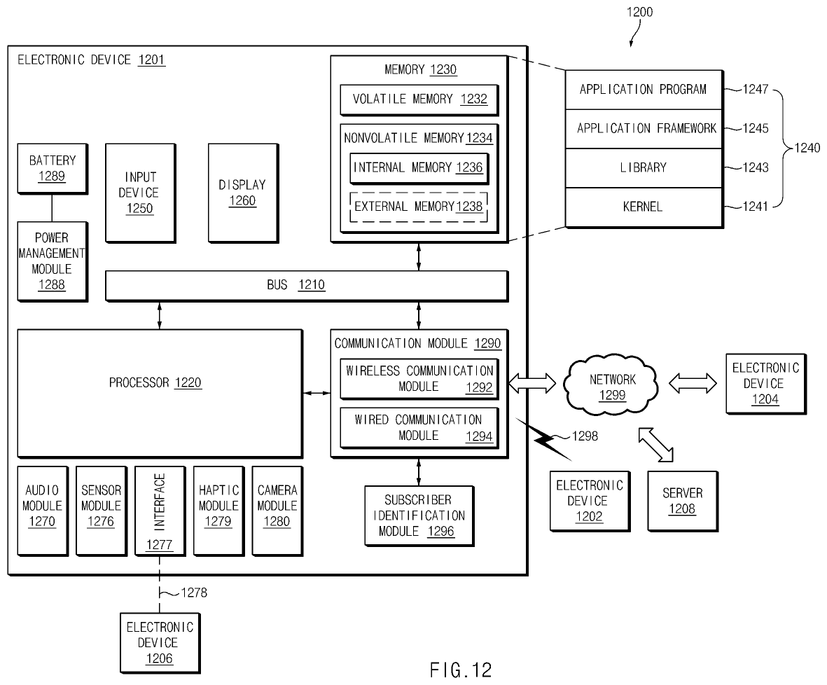

According to an embodiment, the receiver RCV may be activated during a voice call to output a speech received through a communication channel. The speaker SPK may be activated at the time of reproducing a sound source, and output a sound of the reproduced sound source. The receiver RCV and the speaker SPK may receive and output an audio signal (e.g., an audible signal) and a signal of a specified frequency band (e.g., an inaudible signal). Hereinafter, the speaker SPK or the receiver RCV outputting a signal may be understood as the speaker SPK or the receiver RCV receiving a signal from the processor 160 (or the audio module 1270 of FIG. 12) and outputting a sound corresponding to the signal. The audio signal may be, for example, a signal included in a band of 20 Hz to 20 kHz. The signal of the specified frequency band may be, for example, a signal included in at least a partial band (e.g., 20 kHz to 50 kHz) of a of 20 kHz to 100 kHz.

In an embodiment, the receiver RCV and the speaker SPK may be disposed at different positions of the electronic device 10. For example, the receiver RCV may be disposed in a first area of the electronic device 10, for example, in one area of an upper portion of the front surface of the electronic device 10. The speaker SPK may be disposed in a second area of the electronic device 10, for example, in one area of a bottom of the electronic device 10.

According to an embodiment, when each of the first to third microphones MIC1 to MIC3 is activated, each of the first to third microphones MIC1 to MIC3 may detect a sound. The sound may include a signal (or sound) corresponding to an audio signal obtained through the communication module 130 and a signal corresponding to a signal of a specified frequency band. The signal corresponding to the audio signal may include an audio signal, a signal to which the audio signal is converted, a white noise signal, and the like. The first to third microphones MIC1 to MIC3 may be disposed at different positions of the electronic device 10. For example, the first microphone MIC1 and the second microphone MIC2 may be disposed closer to the speaker SPK than the receiver RCV. The first microphone MIC1 may be disposed at the bottom of the electronic device 10 biased toward a first side surface (e.g., right side) of the electronic device 10 when viewed from the front surface of the electronic device 10, and the second microphone MIC2 may be disposed at the bottom biased toward a second side surface (e.g., left side) of the electronic device 10 when viewed from the front surface of the electronic device 10. The third microphone MIC3 may be disposed closer to the receiver RCV than the speaker SPK.

According to an embodiment, the communication module 130 may transmit and receive a signal through a specified communication channel. The specified communication channel may include a channel of at least one communication scheme of 3G, GSM, LTE, WiFi, WiBro, or Bluetooth.

The display 140 may include, for example, at least one of a liquid crystal display (LCD), a light emitting diode (LED) display, an organic light emitting diode (OLED) display, or an electronic paper display. The display 140 may display, for example, a variety of content (e.g., text, images, videos, icons, and/or symbols) to the user. According to an embodiment, the display 140 may be activated (e.g., turned ON) or deactivated (e.g., turned OFF).

The memory 150 may be a volatile memory (e.g., RAM), a nonvolatile memory (e.g., ROM or flash memory), or a combination thereof. The memory 150 may store, for example, commands or data related to at least one other component of the electronic device 10. According to an embodiment, the memory 150 may store commands for detecting a sound or outputting a sound through the input/output device 110. The memory 150 may further include commands for generating a signal of a specified frequency band, and commands for mixing a signal of a specified frequency band and an audio signal.

The processor 160 may include, for example, at least one of a central processing unit (CPU), a graphics processing unit (GPU), a microprocessor, an application processor, a call processor, a codec, and an application specific integrated circuit (ASIC) or a field programmable gate arrays (FPGA), and may have a plurality of cores. The processor 160 may perform operations and data processing relating to control and/or communication for at least one of other components of the electronic device 10.

According to an embodiment, the processor 160 may output signals of the specified frequency band through the receiver RCV and the speaker SPK, respectively, and receive the signals of the specified frequency band which are respectively output through at least one of the first to third microphones MIC1 to MIC3. For example, the processor 160 may output a signal of the specified frequency band (e.g., an inaudible signal) or a signal resulted by mixing the signal of the specified frequency band and the audio signal (e.g., an audible signal) through the receiver RCV at a first time point according to a specified period and detect a sound output via the receiver RCV through the first and second microphones MIC1 and MIC2. For another example, the processor 160 may output a signal of a specified frequency band through the speaker SPK at a second time point according to a specified period, and detect a sound output to the speaker SPK through the first and second microphones MIC1 and MIC2.

In one embodiment, the processor 160 may output a signal of a specified frequency band of one period and may output a signal of a specified frequency band of a plurality of periods. The signal of the specified frequency band may include, for example, at least one of a sine wave, a square wave, a pulse wave, or a sawtooth wave.

In one embodiment, the processor 160 may control the magnitude (or strength) of the signal of the specified frequency band output to the speaker SPK and the receiver RCV. For example, in a default state, the processor 160 may perform control such that a magnitude of the signal of the specified frequency band output to the speaker SPK is not capable of being detected through the first and second microphones MIC1 and MIC2 and is not capable of being detected through the third microphone MIC3. The default state may be a state in which there is no external object close to the electronic device 10. The external object may be, for example, a user or a surrounding object. In another example, the processor 160 may perform settings such that the magnitude of the signal of the specified frequency band output to the receiver RCV in the default state is detected by the first to third microphones MIC1 to MIC3 and is not detected by the third microphone MIC3.

According to an embodiment, the processor 160 may mix a signal of a specified frequency band with an audio signal and output a resulted signal through at least one of the receiver RCV or the speaker SPK. For example, when the processor 160 receives the audio signal through the communication module 130 in a specified first mode (e.g., a general call mode), the processor 160 may mix a received audio (e.g., audible) signal with a signal of the specified frequency band, and output the resulted signal through the receiver RCV. The specified first mode may be, for example, a call mode for outputting a signal of an audible frequency band received through the receiver RCV. For another example, the processor 160 may mix the audio signal received through the communication channel with the signal of the specified frequency band in a specified second mode (e.g., speaker call mode) and output the mixed signal through the speaker SPK. The specified second mode may be, for example, a call mode for outputting an audio signal received through the speaker SPK.

According to an embodiment, the processor 160 may identify a strength of the signal of the specified frequency band which is output through the receiver RCV or the speaker SPK and is detected through the first to third microphones MIC1 to MIC3. For example, the processor 160 may identify strengths of the signals of the specified frequency band which are output through the receiver RCV at a third time point after the first time point and are detected through the first to third microphones MIC1 to MIC3. In another example, the processor 160 may identify the strengths of the signals of the specified frequency band which are output through the speaker SPK at a fourth time point after the second time point and are detected through the first to third microphones MIC1 to MIC3.

According to an embodiment, the processor 160 may determine whether an external object is close to the electronic device 10 or at least one of proximity areas based on the strengths of the signals of the specified frequency band which are identified.

For example, the processor 160 may determine that the electronic device 10 is in a grip state during a call in a specified first mode (call mode) when the strength of the signal of the specified frequency band, which is output through the receiver RCV and detected through the third microphone MIC3 is greater than or equal to a first threshold value and the strengths of the signals of the specified frequency bands, which are output through the speaker SPK and detected through the first and second microphones MIC1 and MIC2 are below second and third threshold values, respectively. For example, the first threshold value may be set to distinguish between the presence and the absence of an external object in front of the electronic device 10. For example, the second and third threshold values may be set to distinguish a front proximity state of an external object to the electronic device 10 and a mid-call grip state of the electronic device 10. The mid-call grip state may be, for example, a state in which an external object grips the electronic device 10 for a call with her or his ear in contact with at least a portion of the front surface of the electronic device 10, for example, the receiver RCV. The front proximity state may be, for example, a state in which the external object is located within a specified distance from the front surface of the electronic device 10 (e.g., the entire front surface). For example, the front proximity state may be a state in which the entire front surface of the electronic device 10 is in contact with the floor as the electronic device 10 is placed upside down on the floor (external object).

In another example, the processor 160 may determine a front proximity state of an external object to the electronic device 10 when the strength of a signal of the specified frequency band, which is output through the receiver RCV and detected through the third microphone MIC3 is greater than or equal to a specified first threshold value and the strengths of the signals of the specified frequency bands, which are output through the speaker SPK and detected through the first and second microphones MIC1 and MIC2 are greater than or equal to second and third threshold values respectively specified for the first and second microphones MIC1 and MIC2.

In another example, the processor 160 may determine a rear proximity state of the external object to the electronic device 10 when the strength of a signal of the specified frequency band, which is output through the receiver RCV and detected through the third microphone MIC3, is less than a specified first threshold value, the strengths of the signals of the specified frequency bands, which are output through the speaker SPK and detected through the first microphone MIC1, is greater than or equal to the second threshold value and less than a fourth threshold value and the strengths of the signals of the specified frequency bands, which are output through the speaker SPK and detected through the second microphone MIC2, are greater than or equal to the third threshold value and less than a fifth threshold value. The fourth threshold value may be a strength value exceeding the second threshold value, and may be set to distinguish a state in which, for example, an external object is close to the rear surface of the electronic device 10 and a state in which the external object is close to the bottom of the electronic device 10. The fifth threshold value may be a strength value exceeding the third threshold value, and may be set to distinguish a state in which, for example, an external object is close to the rear surface of the electronic device 10 and a state in which the external object is close to the bottom of the electronic device 10. The rear proximity state may be, for example, a state in which an external object is located within a predetermined distance from the rear surface of the electronic device 10. For example, the rear proximity state may be a state in which the electronic device 10 is placed on the floor with the rear surface of the electronic device 10 in contact with the floor (an external object).

In another example, the processor 160 may determine a bottom proximity state of the external object to the electronic device 10 when the strength of a signal of the specified frequency band, which is output through the receiver RCV and detected through the first microphone MIC1 is less than a specified first threshold value and the strengths of the signals of the specified frequency bands, which are output through the speaker SPK and detected through the first and second microphones MIC1 and MIC2 are greater than or equal to the fourth and fifth threshold values respectively specified for the first and second microphones MIC1 and MIC2. For example, the bottom proximity state may be a state in which the external object is located within a predetermined distance from the bottom of the electronic device 10.

According to an embodiment, the processor 160 may distinguish a left hand grip and a right hand grip based on a change in the strength of a signal output through the speaker SPK and detected using the first microphone MIC1 and the second microphone MIC2. For example, the first microphone MIC1 may be disposed adjacent to the right side of the electronic device 10, and the second microphone MIC2 may be disposed adjacent to the left side of the electronic device 10. In a case in which the processor 160 determines the bottom proximity state (or a mid-call grip state), the processor 160 may determine the left hand grip state when the change in the strength of the signal detected through the first microphone MIC1 is relatively greater than a change in the strength of the signal detected through the second microphone MIC2. In a case in which the processor 160 determines the bottom proximity state (or a mid-call grip state), the processor 160 may determine the right hand grip state when the change in the strength of the signal detected through the first microphone MIC1 is relatively less than a change in the strength of the signal detected through the second microphone MIC2.

According to an embodiment, the processor 160 may perform a function corresponding to the determined proximity state. For example, the processor 160 may deactivate the display 140 (e.g., turn off the backlight and display of the display) when determining the mid-call grip state or the front proximity state. In another example, when determining the front proximity state, the rear proximity state, or the bottom proximity state, the processor 160 may perform at least one of antenna switching, impedance control, or communication power control of the communication module 130 according to the determined state.

According to an embodiment, the processor 160 may perform different functions in the left hand grip state and the right hand grip state. For example, the processor 160 may change at least one of antenna switching control, impedance control, or communication power control to correspond to each grip state in the left hand grip state and the right hand grip state. In another example, the processor 160 may display an icon displayed on the display 140 differently for the left hand grip and the right hand grip.

According to an embodiment, the processor 160 may calculate a distance to an external object based on a time taken to output a signal of a specified frequency band through the receiver RCV or the speaker SPK and then receive the output signal through two among the first to third microphones MIC1 to MIC3. For example, the processor 160 may calculate a distance between the electronic device 10 and the external object by using a speed of a signal of a specified frequency band (e.g., 340 m/s (15° C.)), a time taken to transmit and receive the signal of the specified frequency band, and a distance between the two microphones.

According to an embodiment, the processor 160 may output the signal of the specified frequency band to the speaker SPK or the receiver RCV, detect the signal of the specified frequency band output through at least one of the first to third microphones MIC1 to MIC3, and calculate a heart rate of the external object based on a change in the strength of the signal of the specified frequency band which is detected. The processor 160 according to an embodiment may detect a heart rate using an inaudible frequency band to prevent an error from occurring in measurement of the heart rate due to an ambient sound of an audible frequency band (the speech of a user).

In the above-described embodiment, the description has been given by taking, as an example, a case in which the electronic device 10 differently set a time point at which a signal of a specified frequency band is transmitted through the speaker SPK and the receiver RCV (time division). However, the electronic device 10 may differently set a frequency of the signal of the specified frequency band output through the speaker SPK and the receiver RCV (frequency division). For example, the electronic device 10 may output a signal of the first specified frequency band through the speaker SPK and output a signal of a second specified frequency band through the receiver RCV.

Although a case in which the electronic device 10 arranges the first to third microphones MIC1 to MIC3 is described as an example in the above-described embodiment, the disclosure is not limited thereto. For example, the electronic device 10 may arrange only the first microphone MIC1 and the third microphone MIC3. As another example, the electronic device 10 may arrange four or more microphones. In this case, the electronic device 10 may arrange at least one of the four or more microphones to be close to the left side or the right side of the electronic device 10.

A case where the electronic device 10 is a bar-shaped device is described with reference to FIGS. 1 and 2. However, the electronic device 10 may be a wearable device including a speaker and a receiver. For example, the wearable device in the form of glasses may detect a proximity of a user by outputting a signal of a specified frequency band and receiving the output signal using a plurality of speakers and at least one microphone.

The electronic device according to an embodiment may perform proximity detection and grip detection using components (a microphone, a speaker, and a receiver) that have been disposed and thus, it is possible to omit sensors such as a proximity sensor and a grip sensor, thereby reducing a mounting space and material cost.

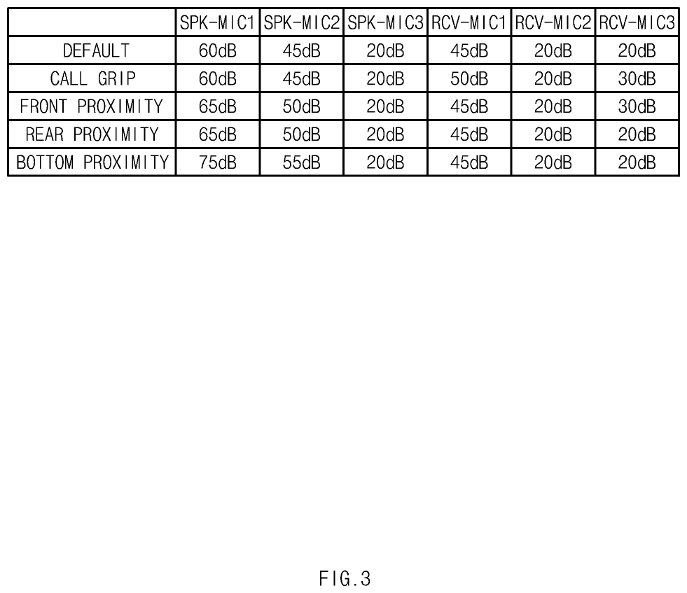

FIG. 3 illustrates a strength of a signal of a specified frequency band in each proximity state according to an embodiment. Pieces of data in FIG. 3 are examples in a case where the speaker SPK is disposed closest to the first microphone MIC1, second closest to the second microphone MIC2, third closest to the third microphone MIC3, and the receiver RCV is disposed closer to the third microphone MIC3 than the first and second microphones MIC1 and MIC2, and the embodiments disclosed herein are not limited thereto.

Referring to FIG. 3, a signal of a specified frequency band output to the receiver RCV in the default state and each proximity state may not be detected by at least one of the first microphone MIC1 or the second microphone MIC2. In addition, a signal of a specified frequency band output to the speaker SPK in the default state and each proximity state may not be detected by the third microphone MIC3. The default state may be the strength of the signal of the specified frequency band detected when there is no external object close to the electronic device 10 within a specified distance.

According to an embodiment, in the mid-call grip state, the strengths of the signals output through the speaker SPK and detected through the first and second microphones MIC1 and MIC2 may be the same as those of the default state, but the strength of the signal output through the receiver RCV and detected by the third microphone MIC3 may be greater than that of the default state. As described above, in the mid-call grip state, as the receiver RCV of the electronic device 10 approaches an ear of the external object (user) of the electronic device 10, when a signal output through the receiver RCV is reflected by the ear of the external object and reaches the third microphone MIC3, the strength of a signal detected by the third microphone MIC3 may become larger and a signal output through the speaker SPK may be hardly affected by an external object.

According to one embodiment, in the front proximity state, the strengths of signals of a specified frequency band, which are output through the speaker SPK and detected by the first and second microphones MIC1 and MIC2 may become lager than that in the default state, and a strength of the signal of the specified frequency band output through the receiver RCV and detected by the third microphone MIC3 may become lager than that in the default state. As described above, in the front proximity state, the signal of the specified frequency band, which is output to the speaker SPK, may be reflected by an external object close to the front surface of the electronic device 10 and detected by the first and second microphones MIC1 and MIC2 with a strength larger than that in the default state, and the signal of the specified frequency band, which is output to the receiver RCV, may be also reflected by an external object close to the front surface of the electronic device 10 and detected by the third microphone MIC3 with a larger strength.

According to one embodiment, in the rear proximity state, the strengths of signals of a specified frequency band, which are output through the speaker SPK and detected by the first and second microphones MIC1 and MIC2 may become lager, but a strength of the signal of the specified frequency band which is output through the receiver RCV and detected by the third microphone MIC3, may be equal to that in the default state. As described above, in the rear proximity state, a signal output to the speaker SPK may be reflected by the external object proximate to the rear surface of the electronic device 10 and be detected as being larger in magnitude, and the signal output to the receiver RCV may not be greatly affected by the external object.

According to one embodiment, in the bottom proximity state, the strengths of signals of a specified frequency band, which are output through the speaker SPK and detected by the first and second microphones MIC1 and MIC2 may become lager than that in the rear proximity state, but a strength of the signal of the specified frequency band output through the receiver RCV and detected by the third microphone MIC3 may be equal to that in the default state. As described above, in the bottom proximity state, the signal output to the speaker SPK may be reflected more by the external object proximate to the bottom of the electronic device 10 than the default state and thus, be detected by the first and second microphones MIC1 and MIC2 as being larger than that in the rear proximity state, and the signal output to the receiver RCV may not be greatly affected by the external object.

As shown in FIG. 3, in each proximity state of the external object to the electronic device 10, a change in the strength of a signal of a specified frequency band which are detected by the first to third microphones MIC1 to MIC3 may occur due to the external object. Accordingly, according to an embodiment, the electronic device 10 may identify a mid-call grip state, a front proximity state, a rear proximity state, or a bottom proximity state based on the detected change in the strength of a signal of a specified frequency band.

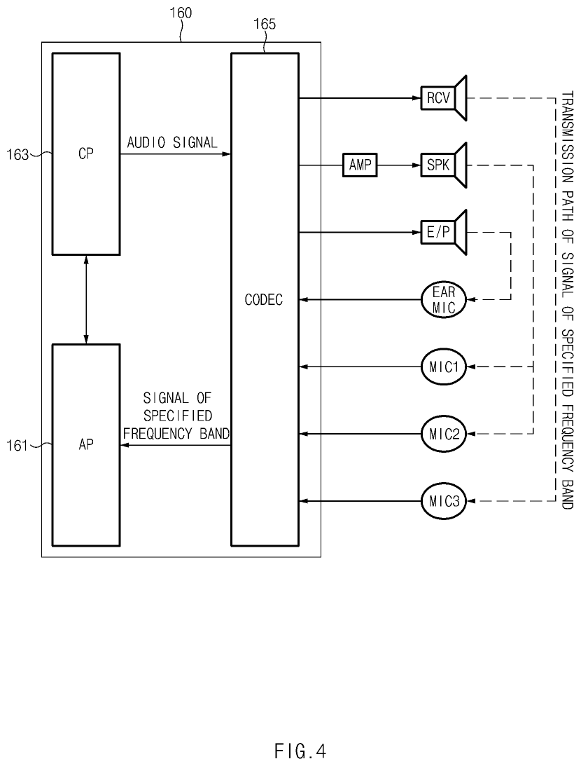

FIG. 4 is a diagram illustrating a transmission/reception path of a signal of a specified frequency band according to an embodiment.

Referring to FIG. 4, according to an embodiment, the processor 160 may include a codec 165, an application processor (AP) 161, and a call processor (CP) 163.

According to an embodiment, the application processor 161 may control each component of the electronic device 10 to execute various applications of the electronic device 10. For example, the application processor 161 may output a signal of a specified frequency band output through the speaker SPK or the receiver RCV at a specified period. The application processor 161 may control the magnitude of the signal of the specified frequency band to be output. For another example, the application processor 161 may identify strengths of signals of the specified frequency band respectively detected through the first to third microphones MIC1 to MIC3. As another example, the application processor 161 may determine a proximity state of an external object to the electronic device 10 based on the strength of the signal of the specified frequency band, and execute a function corresponding to the determined proximity state.

According to an embodiment, the call processor 163 may perform a communication function. The call processor 163 may establish communication using the communication module 130 and perform antenna switching, antenna impedance control, communication power control, or the like. For example, the call processor 163 may decode an audio signal received through the communication module 130 and output the decoded audio signal to the codec 165. For another example, the audio signal received from the codec 165 may be encoded and output (e.g., transferred) to the communication module 130.

According to an embodiment, the codec 165 may perform analog to digital conversion and digital to analog conversion. For example, the codec 165 may convert a first digital signal (e.g., an audio signal) received from the communication module 130 and received through the call processor 163 into an analog signal, and output the analog signal (e.g., as a sound through an output device).

In one embodiment, the codec 165 may mix an audio signal and a signal of a specified frequency band. For example, the codec 165 may mix the first digital signal (audio signal) received from the call processor 163 and the second digital signal (the signal of the specified frequency band) received from the application processor 161, perform conversion into an analog signal, and output the analog signal.

In one embodiment, the codec 165 may convert an analog signal (the audio signal+the signal of a specified frequency band) detected through the first to third microphones MIC1 to MIC3 into a digital signal, separate the signal of the specified frequency band and the audio signal, output the signal of the specified frequency band to the application processor 161, and output the audio signal to the call processor 163.

In one embodiment, the codec 165 may include first to third output paths and first to fourth input paths. The first output path may be a path for outputting an audio signal to, for example, the speaker SPK. The second output path may be a path for outputting an audio signal to, for example, the receiver RCV. The third output path may be a path for outputting an audio signal to, for example, an ear jack receiver (RCV). The first input path may be a path for receiving an audio signal from, for example, an ear jack microphone E/P. The second input path may be a path for receiving an audio signal through, for example, the first microphone MIC1. The third input path may be a path for receiving an audio signal from, for example, the second microphone MIC2. For example, the fourth input path may be a path for receiving an audio signal from, for example, the third microphone MIC3.

In one embodiment, the path through which the codec 165 outputs at least one of the audio signal or the signal of the specified frequency band (hereinafter referred to as an “output path”) is controlled by at least one processor of the application processor 161 or the call processor 163. For example, by controlling the output path of the codec 165, at least one processor may output an audio signal through the receiver RCV in a first mode (e.g., a normal call mode), output a mixed signal (the audio signal+the signal of the specified frequency band) through the receiver RCV at a first time point according to a specified period, and output the signal of the specified frequency band through the speaker SPK at a second time point according to the specified period. In another example, by controlling the output path of the codec 165, the at least one processor may output the mixed signal through the speaker SPK at a second time point according to the specified period in a second mode (e.g., a speaker call mode). As another example, the at least one processor may output the audio signal to a third output path connected to the earjack receiver RCV in a third mode (e.g., earjack call mode), and output the signals of the specified frequency band at the first time point and the second time point to the speaker SPK and the receiver RCV, respectively.

In the above-described embodiment, a case in which the application processor 161 controls transmission and reception of a signal of a specified frequency band has been described as an example. However, the call processor 163 may control transmission and reception of a signal of a specified frequency band in a call state. In this case, the call processor 163 may notify the application processor 161 of transmission and reception of the signal of the specified frequency band.

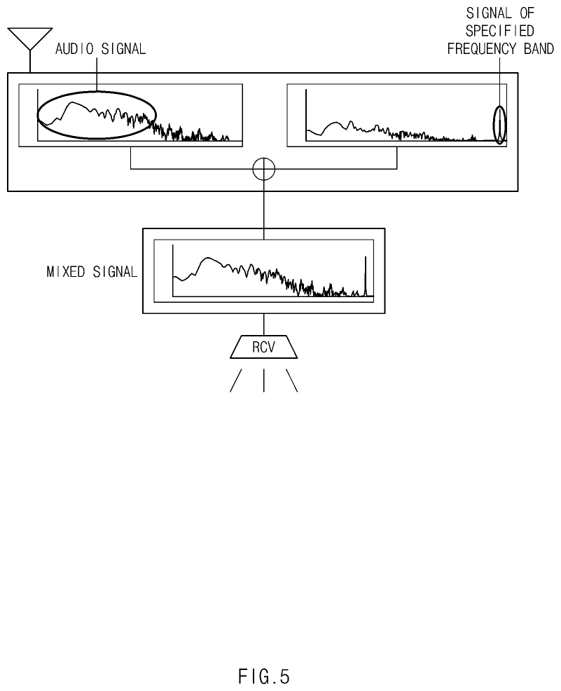

FIG. 5 illustrates a process of mixing an audio signal and a signal of a specified frequency band according to an embodiment. In the graph of FIG. 5, the data on the horizontal axis may be a frequency, and the data on the vertical axis may be a signal strength [dB].

Referring to FIG. 5, the processor 160 may identify an audio signal received through the communication module 130 in a first mode (e.g., a general call mode). The audio signal may be, for example, a voice signal of a user of another electronic device received from another electronic device communicating with the electronic device 10. The processor 160 may generate a signal of a specified frequency band based on data stored in the memory 150 at a specified period, and may mix the signal of the specified frequency band with the audio signal. The mixed signal may be output through the receiver RCV. The signal of the specified frequency band may be a signal of an inaudible frequency band which is not listened to by the user, thus not disturbing the user's call.

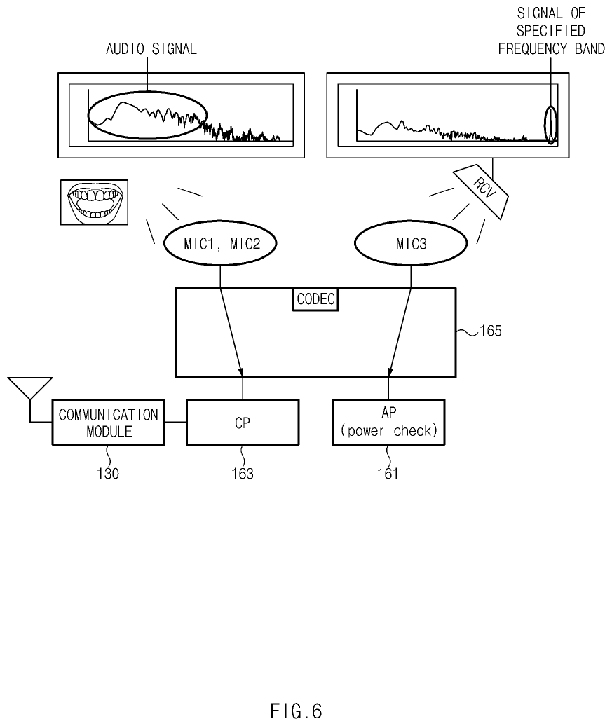

FIG. 6 illustrates a process of transmitting and receiving an audio signal and a process of receiving a signal of a specified frequency band in a first mode according to an embodiment. In the graph of FIG. 6, the data on the horizontal axis may be a frequency, and the data on the vertical axis may be a signal strength [dB].

According to an embodiment, the user's voice (audio signal) for a call in the first mode may be detected through the first microphone MIC1 and the second microphone MIC2. The audio signals detected by the first and second microphones MIC1 and MIC2 may be converted into digital signals by the codec 165 and output to the call processor 163. The call processor 163 may transmit the audio signal to another electronic device in communication with the electronic device 10 through the communication module 130.

According to an embodiment, the third microphone MIC3 may detect the signal of the specified frequency band output through the receiver RCV. The codec 165 may convert the signal of the specified frequency band detected by the third microphone MIC3 into a digital signal. The application processor 161 may identify the strength of the signal of the specified frequency band which has been converted to the digital signal. The application processor 161 may determine a proximity state of the external object based on the identified strength. In one embodiment, the codec 165 may perform channel separation or time division on signals or the like detected through the first to third microphones MIC1 to MIC3 to transmit resulted signals to the application processor 161 and the call processor 163. For example, the codec 165 may output the signal of the specified frequency band to the application processor 161 through one of stereo channels (R channel and L channel), and output the audio signal to the call processor 163 through the other.

According to another embodiment, the electronic device 10 may detect signals of a specified frequency band, which is output through the receiver RCV, using the first microphone MIC1, the second microphone MIC2, and the third microphone MIC3 and detect a proximity based on the strengths detected by the first microphone MIC1, the second microphone MIC2, and the third microphone MIC3.

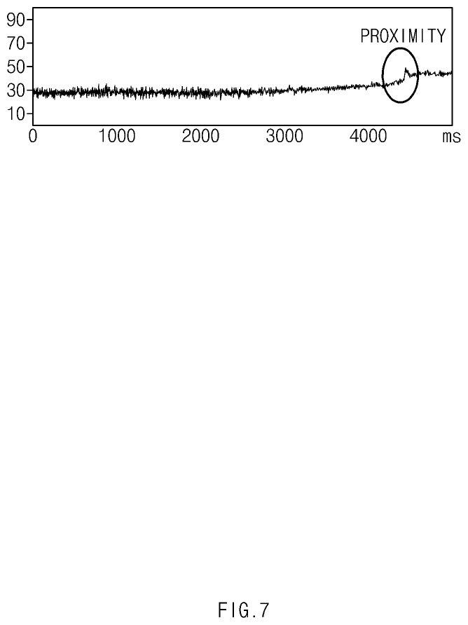

FIG. 7 is a view illustrating a change in magnitude of a signal of a specified frequency band when an electronic device changes from a default state to a bottom proximity state. In FIG. 7, a horizontal axis may be a time axis [ms], and a vertical axis may be a strength axis [dB] of a signal.

As before 4.5 seconds of FIG. 7, in the default state of the electronic device 10, the strength of a signal of the specified frequency band detected by the first microphone MIC1 or the second microphone MIC2 may be about 30 dB. On the other hand, as after 4.5 seconds in FIG. 7, the strength of the signal of the specified frequency band may be about 45 dB which has increased by about 15 dB in the bottom proximity state of the external object. As described above, the processor 160 according to an embodiment may identify the bottom proximity state of the external object by using the change in the strength of the audio signal.

According to an embodiment, an electronic device (e.g., the electronic device 10 of FIG. 2) may include a housing (e.g., the housing 190 of FIG. 2), a communication module (e.g., the communication module 130 of FIG. 2), a first output unit (e.g., the receiver RCV of FIG. 2) disposed in a first area of the housing, a second output unit (e.g., the speaker SPK of FIG. 2) disposed in a second area of the housing, a first microphone (e.g., the third microphone MIC3 of FIG. 2) disposed closer to the first area than the second area, a second microphone (e.g., the second microphone MIC2 of FIG. 2) disposed closer to the second area than the first area, and a processor (e.g., the processor 160 of FIG. 2) operatively connected to the communication module, the first output unit, the second output unit, the first microphone and the second microphone. The processor may acquire an audio signal from an external device through the communication module, output a signal corresponding to the audio signal and a signal of a specified frequency band through the first output unit and the second output unit, determine a proximity state of an external object to the electronic device based on at least a first strength of the signal of the specified frequency band detected through the first microphone and a second strength of the signal of the signal of the specified frequency band detected through the second microphone, and perform a function corresponding to the determined proximity state.

The processor may output the signal of the specified frequency band through the first output unit and determine a mid-call grip state in which the external object grips the electronic device and is positioned within a specified first distance from a front surface of the electronic device when the first strength is greater than or equal to a first threshold value.

The processor may output the signal of the specified frequency band through the second output unit, determine whether the second strength is greater than or equal to a second threshold value when the first strength is greater than or equal to the first threshold value, determine a front proximity state in which the external object is positioned within a specified second distance from the front surface of the electronic device when the second strength is greater than or equal to the second threshold value, and determine the mid-call grip state when the second strength is less than the second threshold value.

The processor may output the signal of the specified frequency band through the first output unit and the second output unit, and determine a rear proximity state in which the external object is positioned within a specified third distance from a rear surface of the electronic device when the first strength is less than the first threshold value, and the second strength is greater than or equal to the second threshold value and less than a third threshold value.

The processor may output the signal of the specified frequency band through the first output unit and the second output unit, and determine a bottom proximity state in which the external object is positioned within a specified fourth distance from a bottom of the electronic device when the first strength is less than the first threshold value, and the second strength is greater than or equal to the third threshold value.

The electronic device may further include a third microphone (e.g., the first microphone MIC1 of FIG. 2) disposed closer to the second microphone than the first microphone and disposed closer to a right side of the electronic device than the second microphone. The processor may identify a third strength of a signal of the specified frequency band which is output through the second output unit and detected using the second strength and the third microphone, and determine a right hand grip state or a left hand grip state by the external object based on changes in the second strength and the third strength.

The processor may control a magnitude of the signal of the specified frequency band output using the first output unit such that the signal of the specified frequency band output to the first output unit is capable of being detected by the first microphone and is not capable of being detected by the second microphone when the external object is not positioned within a specified distance from the electronic device, and control a magnitude of the signal of the specified frequency band output using the second output unit such that the signal of the specified frequency band output to the second output unit is capable of being detected by the second microphone and is not capable of being detected by the first microphone.

The processor may mix the audio signal with the signal of the specified frequency band and output a mixed signal through the first output unit and the second output unit when the obtained audio signal is present, and output the signal of the specified frequency band through the first output unit and the second output unit when the obtained audio signal is not present.

The first output unit may be located in an area of the front surface in an upper portion of the electronic device, and the second output unit may be located in an area of one area of a bottom of the electronic device.

According to an embodiment, an electronic device (e.g., the electronic device 10 of FIG. 2) may include a communication module (e.g., the communication module 130 of FIG. 2), an output device (e.g., at least one of the receiver RCV or the speaker SPK of FIG. 2), a microphone (e.g., at least one of the first to third microphones MIC1 to MIC3), and a processor (e.g., the processor 160 of FIG. 2), wherein the processor may acquire an audio signal from an external device using the communication module, output a signal corresponding to the audio signal and a signal of a specified frequency band through the output device, acquire the signal of the specified frequency band using the microphone, and determine a proximity state of an external object to the electronic device based on a strength of the signal of the specified frequency band and control at least some functions of the electronic device based on at least the determined proximity state.

The output device may include a first output unit (e.g., the receiver RCV of FIG. 2) disposed in a first area of the electronic device, and a second output unit (e.g., the speaker SPK of FIG. 2) disposed in a second area of the electronic device, the microphone may include a first microphone (e.g., the third microphone MIC3 of FIG. 2) disposed closer to the first area than the second area, and a second microphone (e.g., the second microphone MIC2 of FIG. 2) disposed closer to the second area than the first area, and the processor may determine a proximity state of an external object to the electronic device based at least on a first strength of the signal of the specified frequency band detected through the first microphone and a second strength of the signal of the signal of the specified frequency band detected through the second microphone.

The processor may differently set a time point at which the signal of the specified frequency band is output through the first output unit and a time point at which the signal of the specified frequency band is output through the second output unit.

The processor may output a signal of a first specified frequency band through the first output unit, and output a signal of a second specified frequency band through the second output unit.

According to an embodiment, an electronic device include a housing (e.g., the housing 190 of FIG. 2), a communication module (e.g., the communication module 130 of FIG. 2), a first output unit (e.g., the receiver RCV of FIG. 2) disposed in a first area of the housing, a second output unit (e.g., the speaker SPK of FIG. 2) disposed in a second area of the housing, a first microphone (e.g., the third microphone MIC3 of FIG. 2) disposed closer to the first area than the second area, a second microphone (e.g., the second microphone MIC2 of FIG. 2) disposed closer to the second area than the first area, and a processor (e.g., the processor 160 of FIG. 2) operatively connected to the communication module, the first output unit, the second output unit, the first microphone and the second microphone. The processor may output the signal of the specified frequency band through the first output unit and the second output unit, acquire the signal of the specified frequency band using the first microphone and the second microphone, determine a distance between the electronic device and an external object corresponding to the electronic device based on at least a first strength of the signal of the specified frequency band acquired through the first microphone and a second strength of the signal of the signal of the specified frequency band acquired through the second microphone, and control at least some functions of the electronic device based on the distance.

The processor may differently set a time point at which the signal of the specified frequency band is output through the first output unit and a time point at which the signal of the specified frequency band is output through the second output unit.

The processor may output the signal of the specified frequency band through the first output unit and determine that the external object grips the electronic device and is positioned within a specified first distance from a front surface of the electronic device when the first strength is greater than or equal to a first threshold value.

The processor may output the signal of the specified frequency band through the second output unit, determine whether the second strength is greater than the second threshold value when the first strength is greater than the first threshold value, determine that the external object grips the electronic device and is positioned within the specified first distance from a front surface of the electronic device when the second strength is less than the second threshold value, and determine that the external object is positioned within a specified second distance from the front surface of the electronic device when the second strength is greater than or equal to the second threshold value.

The processor may output the signal of the specified frequency band through the first output unit and the second output unit, and determine that the external object is positioned within a specified third distance from a rear surface of the electronic device when the first strength is less than a first threshold value, and the second strength is greater than or equal to a second threshold value and less than a third threshold value.

The processor may output the signal of the specified frequency band through the first output unit and the second output unit, and determine that the external object is positioned within a specified fourth distance from a bottom of the electronic device when the first strength is less than the first threshold value, and the second strength is greater than or equal to the third threshold value.

According to one embodiment, the electronic device may further include a third microphone (e.g., the first microphone MIC3 of FIG. 2) disposed closer to the second microphone than the first microphone and disposed closer to a right side of the electronic device than the second microphone, and the processor may identify a third strength of the signal of the specified frequency band which is output through the second output unit and detected using the second strength and the third microphone, and determine a right hand grip state or a left hand grip state by the external object based on changes in the second strength and the third strength.

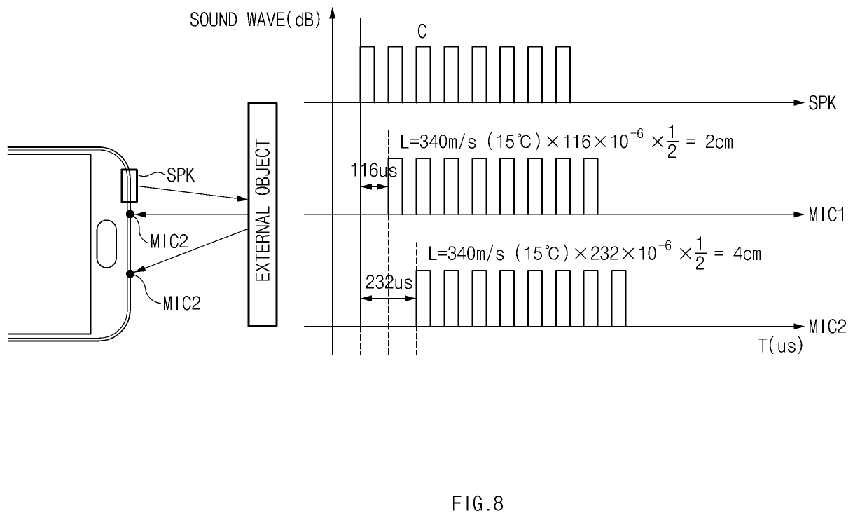

FIG. 8 illustrates a distance detection process using a signal of a specified frequency band according to an embodiment.

Referring to FIG. 8, the processor 160 may calculate a distance to an external object based on a time taken to output a signal of the specified frequency band through the speaker SPK and then detect the signal of the specified frequency band through the first and second microphones. For example, the processor 160 may calculate a distance between the electronic device 10 and the external object by using a time required to transmit and receive the signal of the specified frequency band as shown in Equation 1 below.

L=V×Δt×½ [Equation 1]

In Equation 1, ‘L’ may denote a distance (m) to the external object, and ‘V’ may denote an ultrasonic speed (m/s)=331.5+0.6×T (° C.).

In another example, when a time required to detect the signal of the specified frequency band by the first microphone MIC1 after the signal of the specified frequency band is output through the speaker SPK is 116 μs, the processor 160 may determine 2 cm as the distance between the external object and the first microphone MIC1. When the time required to detect the signal of the specified frequency band by the second microphone MIC2 after the signal of the specified frequency band is output through the speaker SPK is 232 μs, it is identified that the distance between the external object and the first microphone MIC1 is 4 cm. The processor 160 may determine a relative position of the external object based on a distance between the first microphone MIC1 and the second microphone MIC2 and distances between the first and second microphones MIC1 and MIC2 and the external object.

The processor 160 according to an embodiment may determine the distance between and relative positions of the electronic device 10 and the external object using the plurality of microphones MIC1 to MIC3.

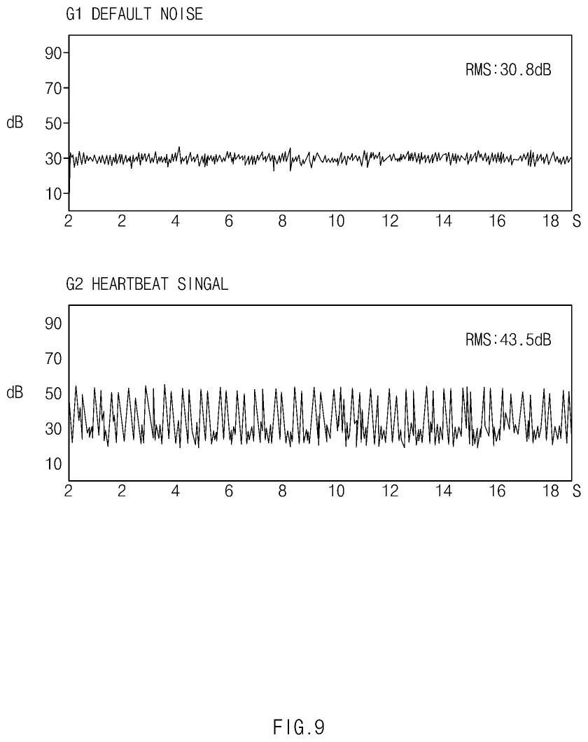

FIG. 9 is a diagram for describing a process of calculating a heart rate using a signal of a specified frequency band, according to an embodiment. A case of calculating a heart rate by outputting a signal of a specified frequency band through the speaker SPK and detecting the signal of the specified frequency band through the first microphone MIC1 will be described as an example.

Referring to FIG. 9, according to an embodiment, graph 1 (g1) may be a signal detected through the first microphone MIC1 in a default state of the electronic device 10. The signal of the specified frequency band detected through the first microphone MIC1 may be, for example, 30 dB.

According to an embodiment, graph 2 (g2) may be the signal of the specified frequency band detected through the first microphone MIC1 while the first microphone MIC1 is close to the heart of a user. The processor 160 may calculate a heart rate of the user by counting two peak changes as one heartbeat from the signal of the specified frequency band because two peak changes occur in the signal of the specified frequency band detected when heartbeat occurs one time.

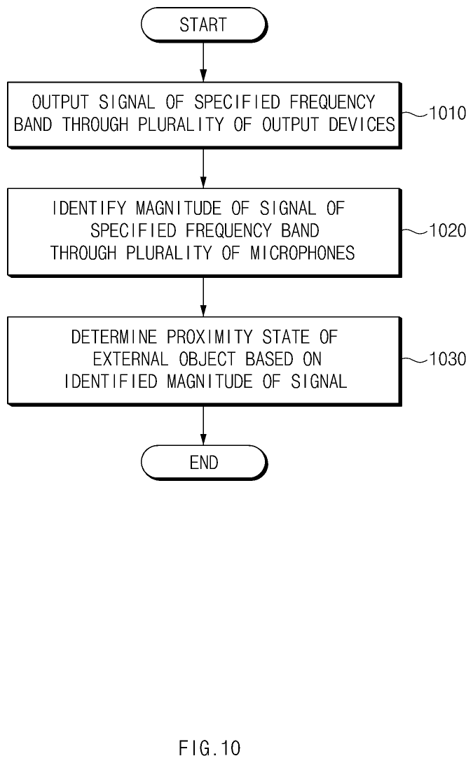

FIG. 10 is a flowchart illustrating a method of detecting a mid-call grip state according to an embodiment.

Referring to FIG. 10, in operation 1010, the processor 160 may output a signal of a specified frequency band through a plurality of output devices (e.g., the receiver RCV and the speaker SPK of FIG. 2). For example, when the processor 160 determines that a call is in progress, in operation 1020, the processor 160 may mix an audio signal received through a communication channel with the signal of the specified frequency band. The processor 160 may output the mixed signal to one output unit allocated for the output of the audio signal among the receiver RCV and the speaker SPK. The one output unit may be, for example, the receiver RCV in a normal call mode using the receiver RCV. For example, the processor 160 may output the signal of the specified frequency band to another output unit which does not output the mixed signal among the receiver RCV and the speaker SPK, at a time point different from a time point at which the mixed signal is output to the one output unit. The other output unit may be the speaker SPK in the normal call mode.

In operation 1020, the processor 160 may identify a strength (or magnitude) of the signal of the specified frequency band through a plurality of microphones (e.g., the first to third microphones MIC1, MIC2, and MIC3).

In operation 1030, the processor 160 may determine a proximity state of the external object to the electronic device 10 based on the strengths of the signals of the specified frequency band identified through the plurality of microphones (e.g., the first to third microphones MIC1, MIC2, and MIC3). For example, when the strength of the signals of the specified frequency band detected through the third microphone MIC3 is greater than or equal to a first threshold value, the processor 160 may determine a mid-call grip state. In another example, the processor 160 may determine the mid-call grip state when a strength of the signals of the specified frequency band detected through the third microphone MIC3 is greater than or equal to the first threshold value and a strength of the signals of the specified frequency band received through the first microphone MIC1 and the second microphone MIC2 is less than a second threshold value and a third threshold value, respectively.

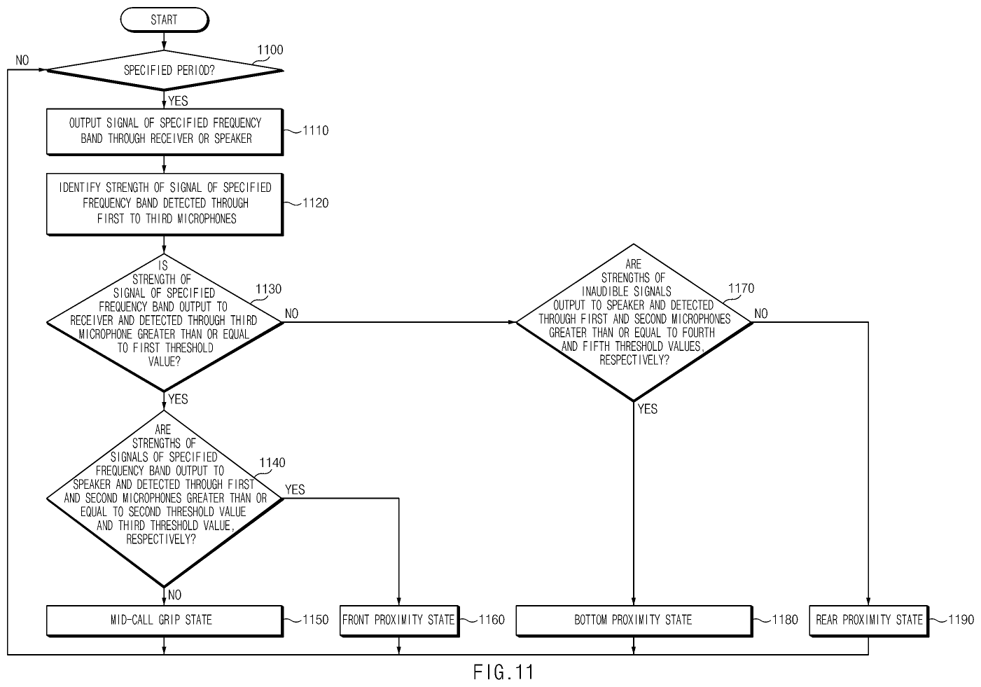

FIG. 11 is a flowchart illustrating a method of determining a proximity state using signals of a specified frequency band according to an embodiment.

Referring to FIG. 11, in operation 1100, the processor 160 may output a signal of a specified frequency band through a receiver RCV or a speaker SPK at a specified period. For example, the processor 160 may output a signal of a specified frequency band through the receiver RCV at a first time point according to a specified period, and output the signal of the specified frequency band through the speaker SPK at a second time point.

In operation 1120, the processor 160 may identify strengths of signals of the specified frequency band respectively detected through the first to third microphones MIC1 to MIC3. For example, the processor 160 may identify a strength of a signal of the specified frequency band which is output through the speaker SPK and detected through the first and second microphones MIC1 and MIC2 and a strength of a signal of the specified frequency band which is output through the receiver RCV and detected through the third microphone MIC3.

In operation 1130, the processor 160 may determine whether the strength of the signal of the specified frequency band output through the receiver RCV and detected by the third microphone MIC3 is greater than or equal to a first threshold value.

In operation 1140, when the strength of the signal of the specified frequency band output through the receiver RCV and detected through the third microphone MIC3 is greater than or equal to the first threshold value, the processor 160 may determine whether strengths of signals of the specified frequency band, which are output through the speaker SPK and detected through the first and second microphones MIC1 and MIC2 respectively, are greater than or equal to the second and third threshold values, respectively.

In operation 1150, when the strengths of the signals of the specified frequency band output through the speaker SPK and detected through the first and second microphones MIC1 and MIC2 are not greater than or equal to the second and third threshold values, respectively, the processor 160 may determine a mid-call grip state by an external object. The processor 160 may deactivate the display 140 when the mid-call grip state is determined. When the processor 160 determines a mid-call grip state, the processor 160 may perform control (e.g., antenna switching, impedance control, or power control) the communication module 130 to correspond to the front proximity state. In another example, the processor 160 may determine whether strengths of the signals of the specified frequency band which are detected through the first and second microphones MIC1 and MIC2 are less than second and third threshold values specified for the first and second microphones MIC1 and MIC2 respectively when the strengths of the signals of the specified frequency band which are detected through the first and second microphones MIC1 and MIC2 are not greater than or equal to the second and third threshold values specified for the first and second microphones MIC1 and MIC2 respectively. In another example, the processor 160 may determine the mid-call proximity state of an external object to the electronic device 10 when the strength of signals of the specified frequency band, which are detected through the first and second microphones MIC1 and MIC2 are less than second and third threshold values respectively specified for the first and second microphones MIC1 and MIC2.

In operation 1150, when it is identified that the strengths of the signals of the specified frequency band output through the speaker SPK and detected through the first and second microphones MIC1 and MIC2 are greater than or equal to the second and third threshold values, respectively, the processor 160 may determine a front proximity state of the external object in operation 1160. When determining the front proximity state, the processor 160 may control the communication module 130 to correspond to the front proximity state.

When it is identified that the strength of the signal of the specified frequency band output through the receiver RCV and detected through the third microphone MIC3 is less than the first threshold value in operation 1130, in operation 1170, the processor 160 may determine whether strengths of signals of the specified frequency band, which are output through the speaker SPK and detected through the first and second microphones MIC1 and MIC2 respectively, are greater than or equal to the fourth and fifth threshold values, respectively.

In operation 1180, when the strengths of the signals of the specified frequency band output through the speaker SPK and detected through the first and second microphones MIC1 and MIC2 are greater than or equal to the fourth and fifth threshold values, respectively, the processor 160 may determine a bottom proximity state of an external object. When the processor 160 determines the bottom proximity state, the processor 160 may control the communication module 130 to correspond to the bottom proximity state.

In operation 1190, when the strengths of the signals of the specified frequency band output through the speaker SPK and detected through the first and second microphones MIC1 and MIC2 are not greater than or equal to the fourth and fifth threshold values, respectively, the processor 160 may determine a rear proximity state of the external object. When the processor 160 determines the rear proximity state, the processor 160 may control the communication module 130 to correspond to the rear proximity state. The processor 160 may determine that the strength of a signal of the specified frequency band which is output through the speaker SPK and detected through the first microphone MIC1 is greater than or equal to the second threshold value and less than a fourth threshold value and the strength of the signal of the specified frequency band, which is output through the speaker SPK and detected through the second microphone MIC2, is greater than or equal to the third threshold value and less than a fifth threshold value when the strengths of signals of the specified frequency band, which are output through the speaker SPK and detected through the first and second microphones MIC1 and MIC2, are not greater than or equal to fourth and fifth threshold values. As a result, In another example, the processor 160 may determine a rear proximity state of the electronic device 10 to an external object when the strengths of the signals of the specified frequency bands, which are output through the speaker SPK and detected through the first microphone MIC1, is greater than or equal to the second threshold value and less than a fourth threshold value and the strengths of the signals of the specified frequency bands, which are output through the speaker SPK and detected through the second microphone MIC2, are greater than or equal to the third threshold value and less than a fifth threshold value.

In the above-described operations 1100 to 1190, the processor 160 may determine that the external object is not in a proximity state when the specified conditions are not met, and may not perform other control.

FIG. 12 is a block diagram illustrating an electronic device 1201 in a network environment 1200 according to various embodiments. Referring to FIG. 12, the electronic device 1201 (e.g., the electronic device 10) in the network environment 1200 may communicate with an electronic device 1202 via a first network 1298 (e.g., a short-range wireless communication network), or an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220 (e.g., the processor 160 of FIG. 2), memory 1230 (e.g., the memory 150 of FIG. 2), an input device 1250 (e.g., the first to third microphones MIC1 to MIC3 of FIG. 2), a sound output device 1255 (e.g., the speaker SPK or the receiver RCV of FIG. 2), a display device 1260 (e.g., the display 140 of FIG. 2), an audio module 1270 (e.g., the CODEC 165 of FIG. 4), a sensor module 1276, an interface 1277, a haptic module 1279, a camera module 1280, a power management module 1288, a battery 1289, a communication module 1290 (e.g., the communication module 130 of FIG. 2), a subscriber identification module (SIM) 1296, or an antenna module 1297 (e.g., the communication module 130 of FIG. 2). In some embodiments, at least one (e.g., the display device 1260 or the camera module 1280) of the components may be omitted from the electronic device 1201, or one or more other components may be added in the electronic device 1201. In some embodiments, some of the components may be implemented as single integrated circuitry. For example, the sensor module 1276 (e.g., a fingerprint sensor, an iris sensor, or an illuminance sensor) may be implemented as embedded in the display device 1260 (e.g., a display).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may load a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thererto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input device 1250 may receive a command or data to be used by other component (e.g., the processor 1220) of the electronic device 1201, from the outside (e.g., a user) of the electronic device 1201. The input device 1250 may include, for example, a microphone, a mouse, a keyboard, or a digital pen (e.g., a stylus pen).

The sound output device 1255 may output sound signals to the outside of the electronic device 1201. The sound output device 1255 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. According to an embodiment, the display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. According to an embodiment, the audio module 1270 may obtain the sound via the input device 1250, or output the sound via the sound output device 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., PCB). According to an embodiment, the antenna module 1297 may include a plurality of antennas. In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. Accordingly, the scope of the disclosure should be construed as including all modifications or various other example embodiments based on the technical idea of the disclosure.

1. An electronic device comprising:
a housing;
a communication module;
a first output unit disposed in a first area of the housing;
a second output unit disposed in a second area of the housing;
a first microphone disposed closer to the first area than the second area
a second microphone disposed closer to the second area than the first area;
a processor operatively connected to the communication module, the first output unit, the second output unit, the first microphone and the second microphone,
wherein the processor is configured to:
acquire an audio signal from an external device through the communication module,
output a signal corresponding to the audio signal and a signal of a specified frequency band through the first output unit and the second output unit,
determine a proximity state of an external object to the electronic device based at least on a first strength of the signal of the specified frequency band detected through the first microphone and a second strength of the signal of the specified frequency band detected through the second microphone, and
perform a function corresponding to the determined proximity state.

2. The electronic device of claim 1, wherein the processor is configured to:
output the signal of the specified frequency band through the first output unit and
determine a mid-call grip state in which the external object grips the electronic device and is positioned within a specified first distance from a front surface of the electronic device when the first strength is greater than or equal to a first threshold value.

3. The electronic device of claim 2, wherein the processor is configured to:
output the signal of the specified frequency band through the second output unit,
determine whether the second strength is greater than or equal to a second threshold value when the first strength is greater than or equal to the first threshold value,
determine a front proximity state in which the external object is positioned within a specified second distance from the front surface of the electronic device when the second strength is greater than or equal to the second threshold value, and
determine the mid-call grip state when the second strength is less than the second threshold value.

4. The electronic device of claim 1, wherein the processor is configured to:
output the signal of the specified frequency band through the first output unit and the second output unit, and
determine a rear proximity state in which the external object is positioned within a specified third distance from a rear surface of the electronic device when the first strength is less than a first threshold value, and the second strength is greater than or equal to a second threshold value and less than a third threshold value.

5. The electronic device of claim 4, wherein the processor is configured to:
output the signal of the specified frequency band through the first output unit and the second output unit, and
determine a bottom proximity state in which the external object is positioned within a specified fourth distance from a bottom of the electronic device when the first strength is less than the first threshold value, and the second strength is greater than or equal to the third threshold value.

6. The electronic device of claim 1, further comprising:
a third microphone disposed closer to the second microphone than the first microphone and disposed closer to a right side of the electronic device than the second microphone,
wherein the processor is configured to:
identify a third strength of the signal of the specified frequency band which is output through the second output unit and detected using the second strength and the third microphone, and
determine a right hand grip state or a left hand grip state by the external object based on changes in the second strength and the third strength.

7. The electronic device of claim 1, wherein the processor is configured to:
control a magnitude of the signal of the specified frequency band output using the first output unit such that the signal of the specified frequency band output to the first output unit is capable of being detected by the first microphone and is not capable of being detected by the second microphone when the external object is not positioned within a specified distance from the electronic device,
control a magnitude of the signal of the specified frequency band output using the second output unit such that the signal of the specified frequency band output to the second output unit is capable of being detected by the second microphone and is not capable of being detected by the first microphone.

8. The electronic device of claim 1, wherein the processor is configured to:
mix the audio signal with the signal of the specified frequency band and output a mixed signal through the first output unit and the second output unit when the obtained audio signal is present, and
output the signal of the specified frequency band through the first output unit and the second output unit when the obtained audio signal is not present.

9. The electronic device of claim 1, wherein the first output unit is located in an area of a front surface in an upper portion of the electronic device, and
wherein the second output unit is located in an area of a bottom of the electronic device.

10. An electronic device comprising:
a communication module;
an output device;
a microphone;
a processor, wherein the processor is configured to:
acquire an audio signal from an external device using the communication module,
output a signal corresponding to the audio signal and a signal of a specified frequency band through the output device,
acquire the signal of the specified frequency band using the microphone, and
determine a proximity state of an external object to the electronic device based at least on a strength of the signal of the specified frequency band and control at least some functions of the electronic device based at least on the determined proximity state.

11. The electronic device of claim 10, wherein the output device includes:
a first output unit disposed in a first area of the electronic device; and
a second output unit disposed in a second area of the electronic device,
wherein the microphone includes:
a first microphone disposed closer to the first area than the second area; and
a second microphone disposed closer to the second area than the first area, and
wherein the processor is configured to determine the proximity state of the external object to the electronic device based at least on a first strength of the signal of the specified frequency band detected through the first microphone and a second strength of the signal of the specified frequency band detected through the second microphone.

12. The electronic device of claim 11, wherein the processor is configured to differently set a time point at which the signal of the specified frequency band is output through the first output unit and a time point at which the signal of the specified frequency band is output through the second output unit.

13. The electronic device of claim 11, wherein the processor is configured to:
output a signal of a first specified frequency band through the first output unit, and
output a signal of a second specified frequency band through the second output unit.

14. An electronic device comprising:
a housing;
a communication module;
a first output unit disposed in a first area of the housing:
a second output unit disposed in a second area of the housing;
a first microphone disposed closer to the first area than the second area
a second microphone disposed closer to the second area than the first area;
a processor operatively connected to the communication module, the first output unit, the second output unit, the first microphone and the second microphone,
wherein the processor is configured to:
output a signal of a specified frequency band through the first output unit and the second output unit,
acquire the signal of the specified frequency band using the first microphone and the second microphone,
determine a distance between the electronic device and an external object corresponding to the electronic device based at least on a first strength of the signal of the specified frequency band acquired through the first microphone and a second strength of the signal of the specified frequency band acquired through the second microphone, and
control at least some functions of the electronic device based on the distance.

15. The electronic device of claim 14, wherein the processor is configured to differently set a time point at which the signal of the specified frequency band is output through the first output unit and a time point at which the signal of the specified frequency band is output through the second output unit.
